(19) United States
(12) Patent Application Publication
(10) Pub. No.: US 2009/0155734 A1
(43) Pub. Date: Jun. 18, 2009

(54) Orthodontic bracket

(76) Inventor: Dwight H. Damon, Spokane, WA (US)

Correspondence Address: WELLS ST. JOHN P.S., 601 W. FIRST AVENUE, SUITE 1300, SPOKANE, WA, 99201, US

(21) Appl. No.: 12/378,193

(22) Filed: Feb. 11, 2009

Related U.S. Application Data
(63) Continuation-in-part of application No. 11/408,873, filed on Apr. 19, 2006.
Application No. 11/408,873 is a continuation-in-part of application No. 12/147,872, filed on Jun. 27, 2008.

(51) Int. Cl. A61C 7/12

(52) U.S. Cl. 433/10

(57) ABSTRACT

An orthodontic bracket is described and which includes a bracket body having an arch wire slot formed therein; and a movable gate which slideably cooperates with the bracket body, and is moveable between a first, open position, to a second, closed position, and wherein the gate is designed so as to minimize the frictional engagement of the arch wire by the gate as the gate is moved from the first open position to the second closed position.

### RELATED PATENT DATA

The present application is a continuation-in-part of U.S. application Ser. No. 11/408,873, filed on Apr. 19, 2006, and application Ser. No. 12/147,872, filed on Jun. 27, 2008.

### TECHNICAL FIELD

The present invention relates to an orthodontic bracket and more specifically to biased ligating slides which are employed with same.

### BACKGROUND OF THE INVENTION

Orthodontic brackets which are attached to the teeth of a patient are designed to engage an arch wire that exerts force upon the teeth to move the teeth into various clinically appropriate orientations. Such brackets typically include an arch wire slot for reception of the arch wire. Those skilled in the art will recognize that an arch wire slot can have any desired cross-sectional configuration or size to match the size and shape requirements of the arch wire or wires that may be received within the same slot.

Those skilled in the art will also recognize that the arch wire, when employed in a typical clinically appropriate situation in a patient's mouth lies in an orientation whereby the arch wire is substantially in an arched or partially curved configuration which closely matches the arched arrangement of the teeth in the respective patient's mouth. Therefore, the arch wire, in most situations, assumes an arched or curved orientation or configuration when it lies within the body of any orthodontic bracket employed for orthodontic treatment.

Heretofore, many orthodontic brackets have been adhesively bonded to a tooth with the arch wire slot being oriented in a substantially parallel orientation relative to the occlusal plane. However, those skilled in the art have long recognized that the arch wire can also be angularly oriented relative to the bracket for certain clinical applications. Previously, orthodontic brackets have included cleat like extensions which have been referred to in the art as tie wings or lugs. These structures project upwardly and downwardly, typically in pairs at the bottom and top of the installed orthodontic bracket. In this regard, these extensions permit an arch wire to be held within the arch wire slot of the bracket by means of a twisted wire (a ligature) or an elastomeric o-ring which is releasably affixed to the respective lugs or tie wings.

The Office's attention is directed to pending U.S. application Ser. No. 12/147,877 which was filed on Jun. 27, 2008. The teachings of this application are incorporated by reference herein. This application which is directed to a self-ligating orthodontic bracket and devices for deploying same, and which further names me as a co-inventor, discloses an orthodontic bracket including a moveable gate member and which further mounts a projecting portion including an elongated pin capable of flexing relative to a central axis thereof and cooperating with a receiving portion to secure the moveable member or gate in at least a closed position. The pin as described is capable of flexing in a generally radial direction which is defined between expanded and contracted states and which permits it to secure the moveable gate member in clinically appropriate positions relative to the bracket body. This arrangement is seen in FIG. 2 of the attached drawings.

The Office's attention is also directed to U.S. Pat. No. 4,248,588 to Hanson and my U.S. Pat. Nos. 5,466,151; and 6,071,118. The teachings of these patents are also incorporated by reference herein. In addition, the Office's attention is directed to the information supplied in my earlier filed patent application Ser. No. 11/408,873 relative to the prior art Carriere SLB Orthodontic Bracket which was introduced by Class One Orthodontics which included a bracket body with a movable cantilevered ligating slide.

While the brackets of the prior art have worked with varying degrees of success, assorted shortcomings have detracted from their usefulness. In particular, one of the chief difficulties of brackets having the designs, as discussed above, relates to the accurate manufacturing of same. Another shortcoming attendant with such prior art devices relates to the dimensional size of such brackets. As should be understood, practitioner's, as well as patients have continually sought after smaller and more inconspicuous brackets in order to acquire or achieve a more aesthetically appealing appearance and increased comfort when the bracket has been installed in the mouth of a patient. Moreover, another shortcoming attendant with such prior art devices relates to the difficulty in employing such orthodontic brackets in connection with arch wires of traditional designs. In this regard, it should be recognized that as the dimensional size of the brackets decrease, the difficulty associated with the closure of the movable ligating slides or gates increases inasmuch as it becomes increasingly difficult for the practitioner to maintain the arch wire within the arch wire slot and simultaneously close the ligating slide without the arch wire either wholly or partially interfering with the movement of the ligating slide to its closed, treatment position by adversely frictionally engaging the arch wire. Still further, the precise rotational control of the bracket body has not been completely achieved because the arch wire often engages the bracket body and gate thereby prohibiting the full rotational control of same.

An orthodontic bracket which avoids many of the shortcomings attendant with the prior art practices and designs utilized heretofore is the subject matter of the present application.

### SUMMARY OF THE INVENTION

A first aspect of the present invention relates to an orthodontic bracket which includes a bracket body having an arch wire slot formed therein; and a movable gate which slideably cooperates with the bracket body, and which further is moveable from a first, open position, to a second, closed position, and wherein the movable gate has a posterior facing surface, and an anterior facing surface, and wherein, in the open position, an arch wire is received in the arch wire slot, and wherein a cavity is formed in the posterior facing surface of the gate so as to minimize the frictional engagement of the arch wire by the gate as the gate is moved from the first open position to the second closed position, and which further improves the rotational control of the bracket body.

Another aspect of the present invention relates to an orthodontic bracket which includes a bracket body having anterior and posterior facing surfaces, and left and right sides, and wherein an arch wire slot having distal ends is formed in the bracket body and extends between the left and right sides of the bracket body, and wherein the arch wire slot has a cross sectional dimension which varies when measured along the arch wire slot, and between the left and right sides of the bracket body; and a gate is slideably borne by the bracket body and is moveable between a first, open position, which permits an arch wire to be received in the arch wire slot, and a second closed position, which captures the arch wire in the arch wire slot in an orthodontic treatment position, and wherein the arch wire slot primarily frictionally engages the arch wire at the distal ends thereof, and in a region adjacent to the left and right sidewalls of the bracket body. This achieves improved rotational control and decreased sliding friction experienced by the bracket body.

Yet another aspect of the present invention relates to an orthodontic bracket which includes a bracket body having an arch wire slot which has a first, and a second end, and an intermediate region, and wherein the arch wire slot has a non-uniform cross sectional dimension when measured between the first and second ends thereof; and a slideable gate cooperating with the bracket body, and which is movable between a first, open position, and a second, closed position, and wherein an arch wire is received in the arch wire slot and is held in an orthodontic treatment position by the movable gate when the gate is located in the second position, and wherein the arch wire slot frictionally engages the arch wire in the vicinity of the first and second ends thereof, and has minimal friction engagement with the arch wire in the intermediate region thereof.

Yet a further aspect of the present invention relates to an orthodontic bracket which includes a bracket body having an anterior and posterior facing surfaces and a width dimension; a substantially transversely disposed arch wire slot formed in the bracket body and which is configured to receive an arch wire therein; and a movable gate which is borne by the bracket body and which is operable when placed in a first, open position, allows the arch wire to be received in the arch wire slot, and wherein the moveable gate has an anterior facing surface, and an opposite posterior facing surface, and wherein the gate slideably cooperates with the bracket body so as to releasably secure the moveable gate in a second, closed position, and which further retains the arch wire in the arch wire slot in an orthodontic treatment position relative to the bracket body, and wherein a portion of the posterior facing surface of the gate forms a cavity such that the arch wire is not substantially frictionally engaged by the moveable gate at it moves between the first, open position to the second closed position, and which further allows for enhanced rotational control across the entire width of the bracket body.

Moreover, another aspect of the present invention relates to an orthodontic bracket which includes a bracket body having left and right sides, and a width dimension, and wherein an arch wire slot is defined by the bracket body, and extends across the width dimension of the bracket body between the left and right sides thereof, and wherein the arch wire slot is defined by top and bottom surfaces, and a rearward surface which extends between the top and bottom surfaces, and wherein the arch wire slot further has a first end, having a first cross sectional dimension which is located adjacent to the left side of the bracket body, and a second end, having a second cross sectional dimension substantially similar to the first cross sectional dimension, and which is located adjacent to the right side of the bracket body, and wherein the arch wire slot further has an intermediate region located between the first an second ends thereof, and which has a cross sectional dimension greater than either of the first or second cross sectional dimension; and a slideable gate cooperating with the bracket body, and which has an anterior and a posterior facing surface, and which is moveable between a first, open position, which allows an arch wire to be received in the arch wire slot, and which is further moveable to a second, closed position, which locates the arch wire in an orthodontic treatment position within the bracket body, and wherein a cavity or cavities of different sizes and/or shapes is formed in one of the top, bottom and rearward surfaces which define the arch wire slot, or the posterior surface of the slideable gate, so as to reduce the amount of friction experienced by the arch wire and the gate when the arch wire is located in the orthodontic treatment position and within the bracket body.

Still yet another aspect of the present invention relates to an orthodontic bracket which includes a bracket body having multiple surfaces which define an arch wire slot, and wherein the arch wire slot has opposite first and second ends, and an intermediate region between the first and second ends, and wherein the arch wire slot has a cross sectional dimension which is greatest in the intermediate region thereof; and a slideable gate which matingly cooperates with the bracket body, and which is moveable between a first, open position, which allows an arch wire to be received in the arch wire slot, and a second, closed position, which encloses and orients the arch wire in an orthodontic treatment position in the arch wire slot, and wherein the arch wire is spaced from one of the multiple surfaces which define the arch wire slot or the slideable gate in the vicinity of the intermediate portion of the arch wire slot.

Another aspect of the present invention relates to an orthodontic bracket which includes a bracket body defining an arch wire slot which extends across the width thereof, and wherein the arch wire slot has a first and second end, and an intermediate region; and a slideable gate moveably cooperating with the bracket body, and which is moveable between a first, open position, which permits an arch wire to be received therein, and a second, closed position, and wherein the bracket body engages the arch wire in the vicinity of the first and second ends of the arch wire slot, and has minimal contact with the arch wire in the vicinity of the intermediate region of the arch wire slot. This permits accurate rotational control of the bracket body across its entire width. This also decreases the sliding friction which is created between the bracket body, and the arch wire.

Another aspect of the present invention relates to an orthodontic bracket which includes a bracket body defining an arch wire slot; an arch wire received in the arch wire slot; and a moveable gate cooperating with the bracket body and which is moveable between a first open position which allows the arch wire to be received in the arch wire slot, and a second closed position, and wherein the moveable gate has a posterior facing surface which does not substantially frictionally engage the moveable gate when the moveable gate moves between the first and second positions.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 is a perspective, exploded, front elevation view of one form of the orthodontic bracket of the present invention and with some underlying surfaces shown in phantom lines.

FIG. 2 is a second, perspective, exploded, front elevation view of another form of the orthodontic bracket of the present invention.

FIG. 3 is a fragmentary, posterior, side elevation view of a first form of a moveable gate employed with the present invention.

FIG. 3A is an alternative, posterior, side elevation view of one form of a moveable gate used with the present invention.

FIG. 4 is an alternative, posterior, side elevation view of yet another moveable gate used with the present invention.

FIG. 4A is an alternative, posterior, side elevation view of another form of a moveable gate used with the orthodontic bracket of the present invention.

FIG. 5 is still another, posterior, side elevation view of a moveable gate used with the present invention.

FIG. 5A is still another, posterior, side elevation view of a moveable gate used with the present invention.

FIG. 6 is still another, posterior, side elevation view of a moveable gate used with the present invention.

FIG. 6A is still another posterior, side elevation view of a moveable gate which finds usefulness in the present invention.

FIG. 7 is a perspective, fragmentary, environmental view of the orthodontic bracket of the present invention and wherein a deployed arch wire is received in the arch wire slot, and the moveable gate of the orthodontic bracket is shown in a first, open position permitting the arch wire to be received in the arch wire slot.

FIG. 8 is a second, perspective, side elevation view of the orthodontic bracket of the present invention and which shows a deployed, curved arch wire received in the arch wire slot thereof, and the moveable gate located in a second closed position thereby capturing the arch wire in an acceptable orthodontic treatment position within the defined arch wire slot.

FIG. 8A is a fragmentary, transverse, horizontal sectional view taken from a position along line 8A-8A in FIG. 8.

FIG. 9 is a perspective, exploded view of another form of the orthodontic bracket of the present invention.

FIG. 9A is a perspective, exploded view of yet another form of an orthodontic bracket of the present invention.

FIG. 10 is a fragmentary, perspective view of the orthodontic bracket of the present invention with exterior surfaces shown in phantom lines so as to illustrate the features of one form of the arch wire slot in the present invention.

FIG. 10A is a top plan view taken from a position along line 10A-10A in FIG. 10.

FIG. 11 is a transverse, vertical sectional view of the orthodontic bracket of the present invention and which is taken from a position along line 11-11 of FIG. 8.

FIG. 12 is a transverse, vertical sectional view of the orthodontic bracket of the present invention and which is taken from a position along line 12-12 of FIG. 8.

FIG. 13 is a transverse, vertical sectional view of the orthodontic bracket of the present invention and which is taken from a position along line 13-13 of FIG. 8.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

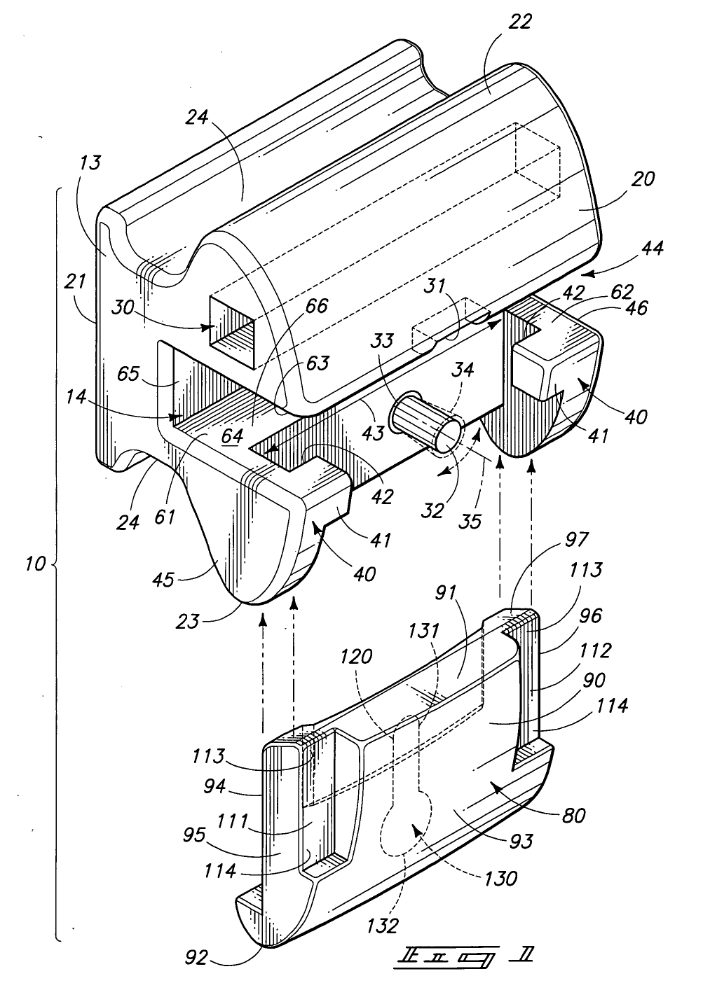

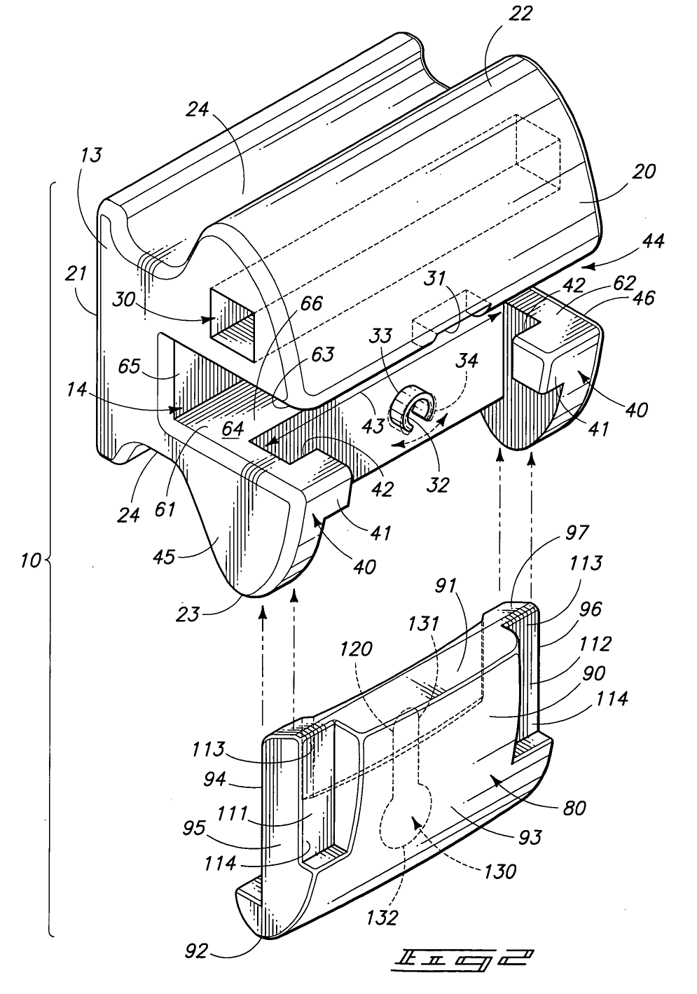

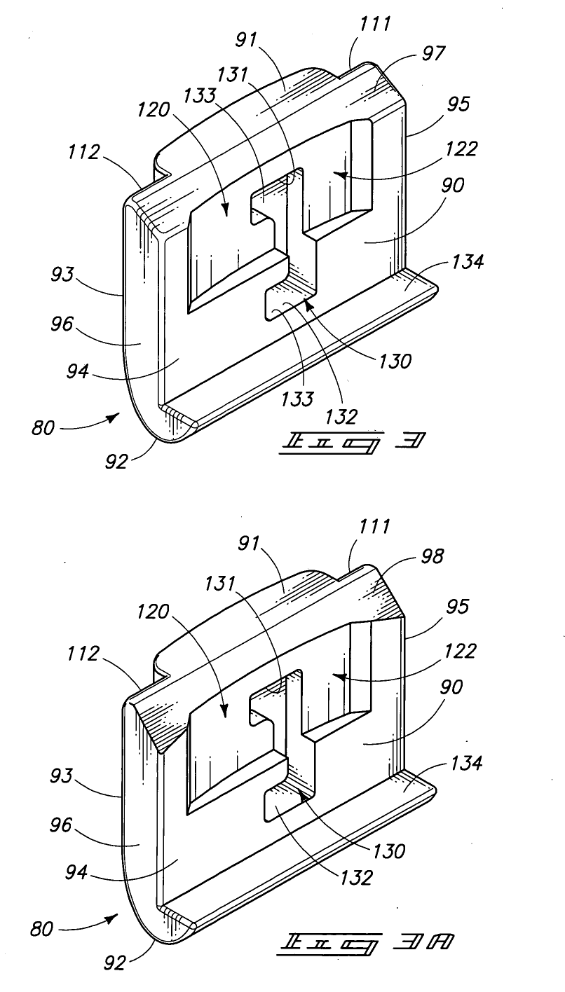

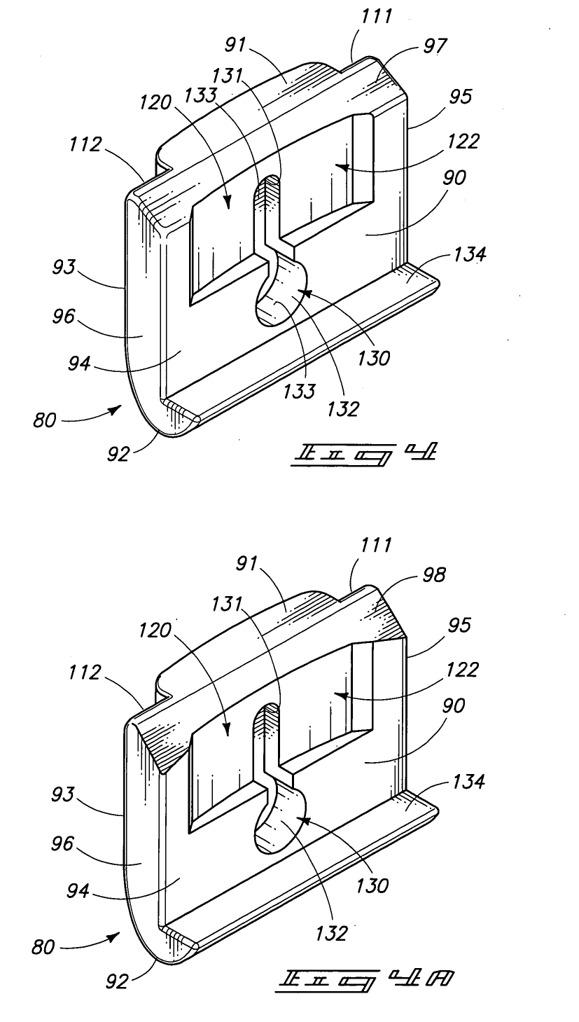

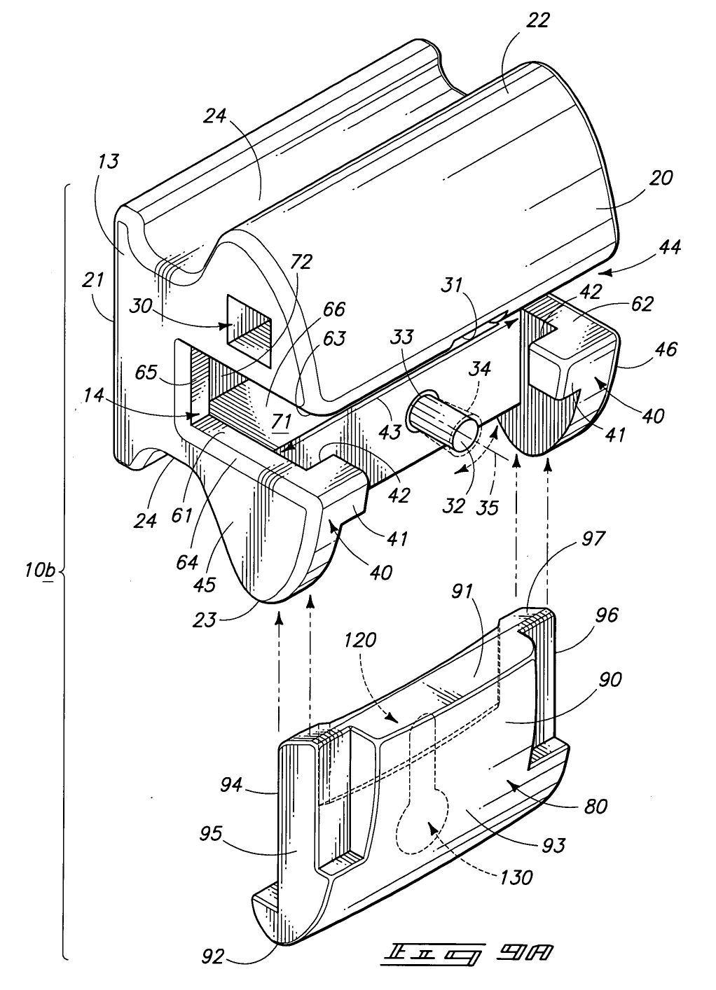

Referring now to FIG. 1, one embodiment of the orthodontic bracket of the present invention is designated by the numeral 10 therein. As will become evident, several forms of the orthodontic bracket of the present invention are shown in the drawings. In this regard, another embodiment is shown in FIG. 2. Either the first or second embodiments may use the various forms of moveable gates as seen in FIGS. 3, 4, 3A, 4A, 5, 6 and 5A and 6A. Further, another form of the invention is shown in FIGS. 9 and 9A. Still other inventive aspects of the present forms of the orthodontic bracket will be discussed in greater detail, hereinafter. The teachings of the earlier priority applications are incorporated by reference herein.

The illustrated details of the orthodontic brackets of the present invention may be used in many different combinations within the scope of this disclosure. For this reason, the details of the illustrated orthodontic brackets as described hereinafter are intended to be interpreted as merely illustrative and should not be taken as restrictive of the practical combinations of such features within the scope of this disclosure and the appended claims as provided for hereinafter. When referring to the illustrated forms of the orthodontic bracket as will be described hereinafter, the component parts and more specifically the front surfaces thereof and which are directed outwardly from a supporting tooth shall be referred to as the anterior surface. Conversely, it's rear surfaces, that is, those facing toward the tooth, shall be termed the posterior surfaces. Directions along a bracket assembly, and which are generally parallel to the incisal or occlusal plane shall be referred to as having width and/or being transverse. Conversely perpendicular directions extending in generally upright orientations between the gingival line and the incisal or occlusal line shall be referred to as the height of the bracket assembly. The upright surfaces of the bracket shall be termed its side surfaces, and surfaces along the top and bottom of the bracket shall be termed the incisal or occlusal surfaces or the gingival surfaces respectively. When referring to the directions of movement of the ligating slide or gate of the present orthodontic bracket, the term inferior or superior shall be used in an anatomical sense, that is, oriented in relation to the patient wearing the bracket. Thus, if a ligating slide is moved inferiorly it would be moved in a downward direction (toward the earth). Conversely, if it is moved superiorly, it would be moved in an upward direction (away from the earth).

The arch wire slot shown in the attached drawings are generally aligned and oriented transversely across each orthodontic bracket in a direction which is usually parallel to the incisal or occlusal surfaces for general illustration purposes only. However, the arch wire slot across each bracket can be oriented in any desired angular configuration relative to its incisal or occlusal surfaces to effect any desired degree of tipping to support a tooth. In addition, the orthodontic bracket can be oriented angularly relative to a supporting pad, thereby providing an angular force to the arch wire slot, and engaged arch wire, when secured to a supporting tooth. In order to properly fit upon the exterior surface of a selected tooth, the posterior surface across the pad for each bracket must be molded or otherwise formed to conform to the tooth, with the arch wire slot at the desired angular relationship to the arch wire installation. Various placement angles can be provided on selected orthodontic brackets by rotating the anterior surface contour across the pads of the brackets within a set. Alternatively, the arch wire slots and a set of brackets can be arranged in selected angles by rotating the position of the protruding elements of each bracket relative to a pad having a properly contoured posterior surface. The arch wire slot is then formed in the protruding portion of the bracket to match the amount of tipping to be imparted to a given tooth. While the illustrated arch wire slot, and the various forms of the invention are shown in a perpendicular orientation relative to the anterior surface of the bracket, it could be formed in any desired angle relative to the anterior surfaces depending upon the desired torquing to which the supporting tooth is to be subjected. The illustrated orthodontic brackets, as shown herein, are designed to be bonded directly to a tooth at either the facial or lingual tooth surfaces.

The present orthodontic brackets as described herein can be made from any suitable moldable material including, but not limited to, metals, plastics and ceramics as well as a combination of such materials. The brackets as shown herein are typically fabricated out of metal, but the choice of materials is not critical to the understanding or the subsequent clinical, and end use of the invention. The only limitation with regard to the chosen material(s) is the ability to efficiently fabricate or mold the orthodontic bracket and the accompanying ligating slide or gate as structures which are capable of moving one relative to the other and which are operable to enclose the arch wire within the orthodontic bracket in an appropriate orthodontically effective treatment position during an orthodontic procedure.

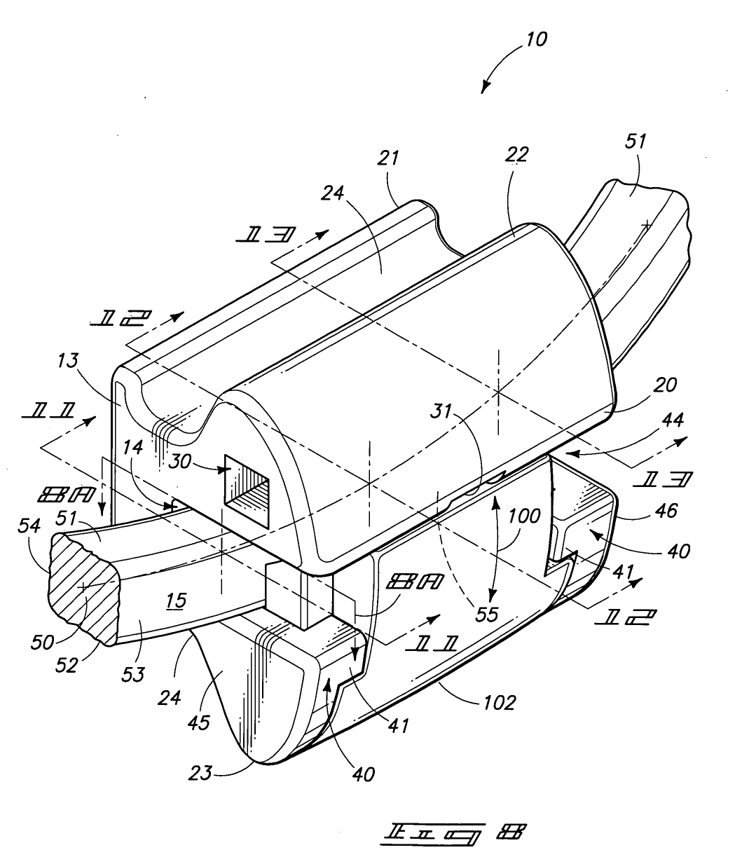

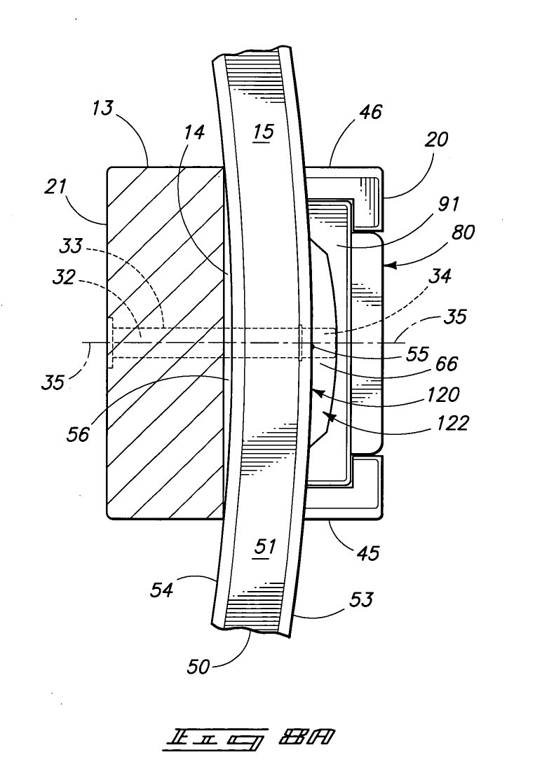

Referring now to FIG. 1, one form of the orthodontic bracket of the present invention is shown therein. It should be understood that multiple forms of the invention are illustrated. For ease of understanding, common structures bear that same reference number. As will be appreciated, the orthodontic bracket 10, as seen in that view, finds usefulness when used in an orthodontic procedure which effects a plurality of teeth (not shown) within a patients mouth. It is well known to those skilled in the art, that each of the teeth within a patients mouth have an exterior (facial) facing surface upon which the bracket body or base member 13 is typically affixed by using an appropriate adhesive. It will be appreciated that the same invention could be used on the lingual surface of a tooth. It will be seen by reference to FIG. 1 that the base member or bracket body 13 defines a substantially transversely disposed arch wire slot 14 which extends thereacross the bracket body, and which is further operable to receive a suitable rectangular shaped arch wire 15 therein. As seen in FIG. 7 and following, the arch wire 15 is illustrated in an appropriate, seated, orthodontic treatment position within the arch wire slot 14. It will be recognized, however, that under some circumstances, and particularly when the arch wire is first installed, that is, received in the arch wire slot 15, that it may not be appropriately positioned or received completely within the arch wire slot. The present invention as will be described below is operable to facilitate the successful passive self-ligation of the rectangular shaped arch wire 15 in a fashion not possible heretofore. For example, during the treatment of a patient, orthodontic brackets occasionally detach from the underlying tooth (not shown). Further, teeth occasionally move following this detachment. If this occurs, the various forms of the orthodontic bracket as will be disclosed herein can be reattached to the tooth at its correct position and the arch wire may be reinserted into the arch wire slot 14 and the ligating slide or gate closed as will be described below without the need of replacing the arch wire 15 with a smaller dimensioned arch wire which has previously been the accepted practice. This feature of the invention is facilitated by the resiliency of the ligating slide or gate as will be described hereinafter, and the design of the arch wire slot and posterior facing surface of the gate as will be described, hereinafter. Additionally, the present invention provides significant time savings for the treatment of a patient. The features of the new and novel orthodontic brackets of the present invention will be described in the paragraphs which follow.

Referring still to FIG. 1, it will be seen that the bracket body or base member 13 of one form of the invention 10 has an anterior facing surface or side 20, and an opposite, posterior facing surface or side 21 which is adhesively affixed to the exterior (facial) surface of a tooth in a patients mouth (not shown). The base member 13 further has a top or superior facing surface or portion 22, and an opposite, lower, or inferior surface or portion 23. As seen in several of the transverse, vertical, sectional drawings, opposite, substantially transversely oriented channels 24 are defined in the superior, and inferior facing surfaces, and are further located therebetween the anterior and posterior facing surfaces 20 and 21. These channels may be useful for securing various other dental appliances therein. More specifically, the superior portion 22, and the inferior or lowermost portion 23 define substantially continuous upper and lower tie wing projections which can be employed in various orthodontic treatment regimens.

Referring still to FIG. 1, and following, it will be seen that the bracket body or base member 13 has a transversely substantially square or rectangular shaped passageway 30 formed in the superior portion 22 of the base member. As illustrated in that figure, and the ones that follow, it will be seen that the passageway 30 extends completely through the base member 13, and further is disposed in substantially parallel spaced relation relative to the arch wire slot 14. It should be understood that if the arch wire slot 14 is located in an orientation other than the transverse orientation as depicted in these drawings, then this parallel orientation would not necessarily exist. However, it should be understood that the transverse passageway 30 may receive or cooperate with another secondary arch wire; post; and/or other orthodontic appliances, as described in the earlier priority applications, and which are useful in treating various tooth anomalies.

As seen in FIG. 1 and following, a recess 31 is formed, at least in part, in the anterior facing surface 20 and one of the adjacent surfaces of the bracket body 13 which defines the arch wire slot 14. This recess 31 is useful for inserting a dental tool or other instrument therein in order to effect downward or inferior movement of the ligating slide or gate, as will be discussed in greater detail, hereinafter. As seen in FIG. 1 and following, one form of the orthodontic bracket 10 includes at least one post, projection, or resilient member 32 which extends outwardly relative to the base member 13, and which further is received within a bore 33. This bore is formed in the base member 13 and is located near the inferior portion or surface 23. In the present invention the post or resilient projection or pin 32 is received, at least in part, in the bore 33 and extends anteriorly outwardly relatively to the base member 13. As depicted in FIG. 1, the projection 32 is depicted as being substantially cylindrical and further the projection has an exterior facing surface 34. As will be discussed in greater detail hereinafter, the projection resiliently cooperates with the ligating slide or gate, as will be described hereinafter, in order to define, at least in part, a course of movement for the ligating slide or gate. This feature will also be discussed in greater detail below. As will be appreciated from a study of the drawings, the bore 33 is sized so as to matingly, telescopingly receive, and secure the projection or resilient member 32 therein. In the assembly of the present invention, it should be understood that the projection will be asserted in the bore typically from the posterior facing surface or side 21 of the base member 13. However, it is conceivable that the post, pin or resilient member 32 can be inserted forcibly from the anterior side 20, as in the nature of a friction-fit. Therefore, in alternative forms of the invention, the bore 33 may or may not extend through the base member 13 depending upon the manufacturing technique employed. As seen in FIG. 1 and following, the post, pin or resilient member is resiliently moveable about the central, longitudinal axis thereof 35 and in a generally, radially outward or lateral direction relative to the central or longitudinal axis of the resilient member or post so as to resiliently cooperate with the moveable ligating slide or gate as will be described in greater detail hereinafter.

As discussed, above, the post or resilient member 32 defines a course of travel for the biased slide or gate, as will be described, below. As seen in the drawings, the anterior facing surface 20 of the base member 13 defines a pair of spaced substantially inwardly extending guide members which are generally indicated by the numeral 40. The guide members 40 have an exterior facing surface 41, and an opposite interior facing surface 42 which defines, at least in part, a generally vertically oriented slide or gate channel 43. As seen in the drawings, the post or resilient member 32 extends anteriorly outwardly from the base member 13, and partially occludes this substantially vertically oriented slide, or gate channel 43 for purposes of resiliently or biasingly cooperating with the slide or gate which will be described, below. As seen in the drawings, the bracket body or base member 13 defines an opening 44 in the anterior facing surface 20 through which the arch wire 15 may be inserted into the arch wire slot 14 as will be described also in greater detail below. Again, the operation of the slide or gate that is received within this substantially vertically oriented slide or gate channel 43 will be described in greater detail, below.

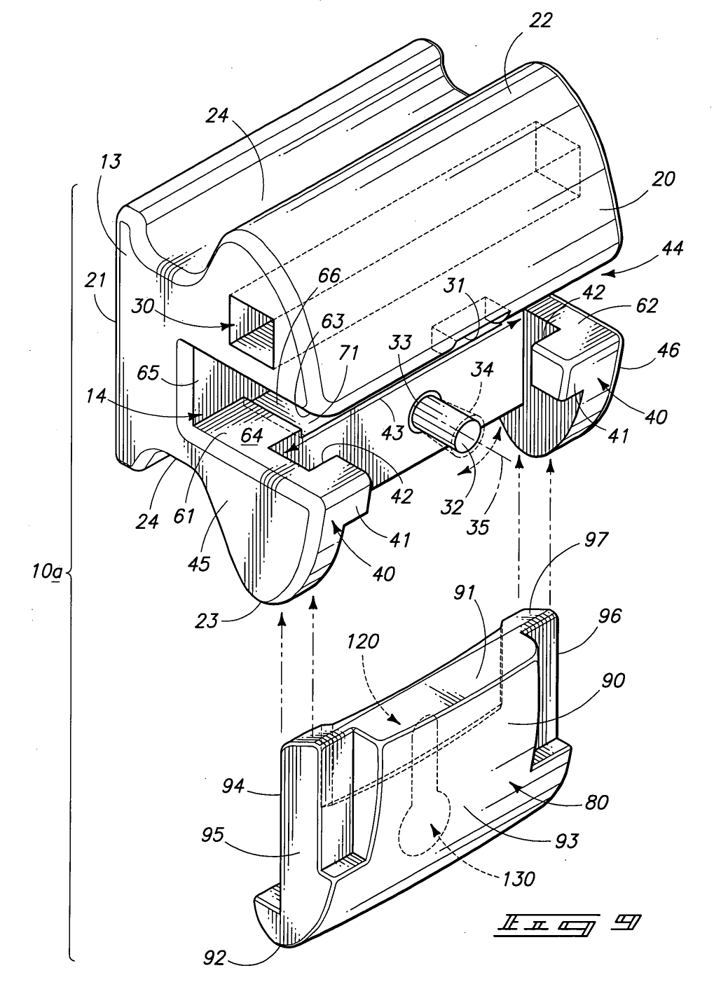

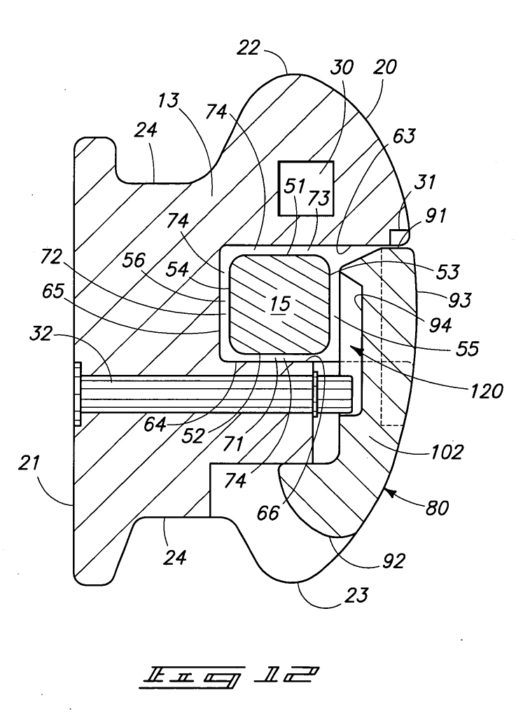

With respect to the several forms of the invention which are described, it will be understood that the bracket body 13 as described hereinafter includes left and right sidewalls which are generally indicated by the numerals 45 and 46, respectively. Still further, it will be appreciated that the rectangular shaped arch wire 15 is received in the arch wire slot 14 has a main body 50 (FIG. 7) which is defined by first, second, third and fourth surfaces 51-54, respectively. When appropriately positioned within the mouth of a patient (not seen), it will be understood that the arch wire 15 assumes an orientation which is curved or arched as seen most appropriately in FIGS. 7 and 8A. When received within or pushed through the arch wire slot opening 44, and moved into an appropriately seated orthodontic treatment position within the arch wire slot 14 as seen in FIGS. 7 and 8A, the arch wire 15 has a maximum arc magnitude 55 relative to the arch wire slot 14. Once positioned within the arch wire slot 14, it will be understood therefore that because of this maximum arc magnitude 55, a portion of the arch wire 15 projects forwardly slightly relative to the intermediate region of the arch wire slot 14. Because of this orientation of the arch wire, it has often impeded or made difficult, the effective closing of the moveable slide or gate as will be described in greater detail below. As seen most clearly by reference to FIGS. 8A and 12, at the maximum arc magnitude 55 relative to the arch wire slot 14, the arch wire 15 is typically spaced a given distance 56 from the bracket body 13.

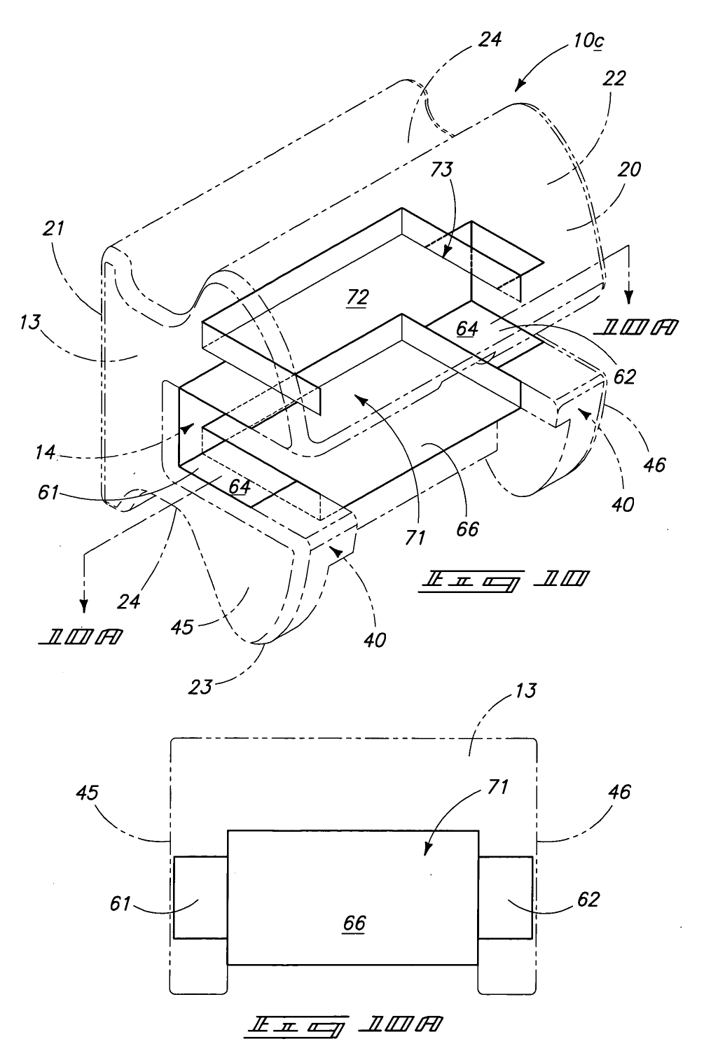

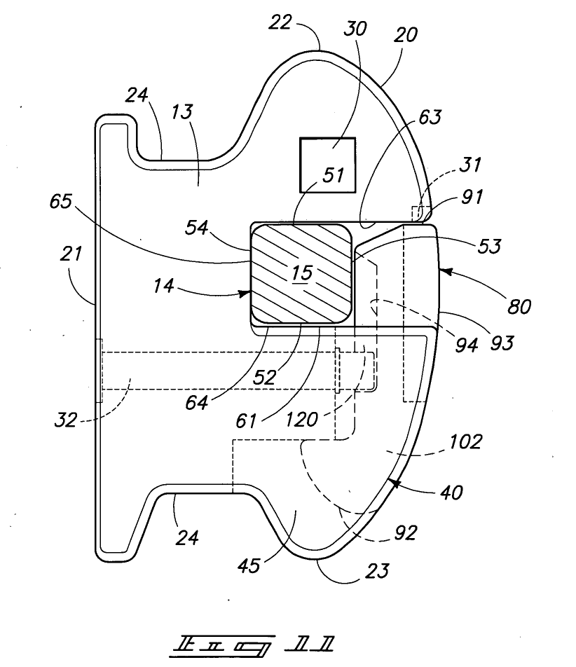

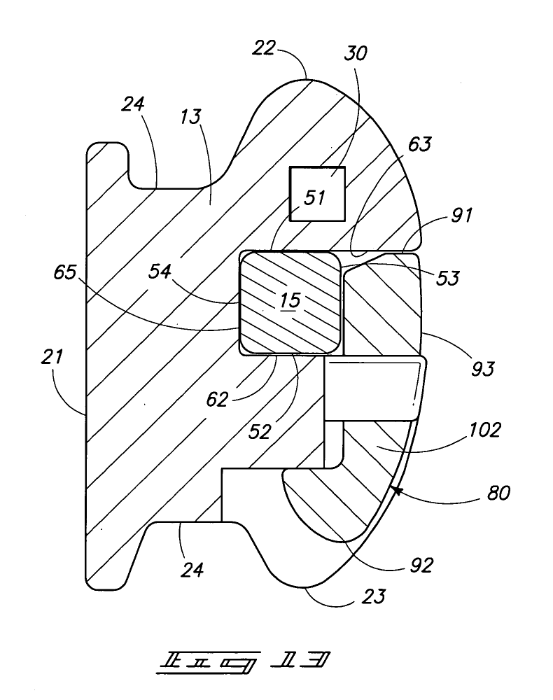

Referring to FIG. 1 and following, the bracket body 13, as earlier described, has formed therein an arch wire slot 14 which extends between the left sidewall 45, and the right sidewall 46 thereof. In this regard, the arch wire slot has a first end 61, which is positioned near the left sidewall 45, and an opposite second end 62, which is positioned near the right sidewall 46 of the bracket body 13. Still further, the arch wire slot is defined by a multiplicity of surfaces, those being a top surface 63, and an opposite bottom surface 64. Still further, a rear wall or posteriorly oriented surface 65 is defined by the bracket body 13, and extends between the top and bottom surfaces 63 and 64. The arch wire slot has an intermediate region or portion 66. As will be understood from a study of FIG. 1, and following, the arch wire slot 14 has a first substantially uniform cross-sectional dimension when measured adjacent to the first and second ends thereof 61 and 62; and a second cross-sectional dimension when measured at a location intermediate 66 the first and second ends of the arch wire slot 14. In one form of the invention 10A as seen in FIG. 9, it will be understood that the second cross-sectional dimension as measured in the intermediate region 66 is greater than the first cross-sectional dimension (adjacent the first and second ends 61 and 62) inasmuch as a first cavity 71 is formed in the bottom surface 64 of the arch wire slot. Still further, and referring to another form of the invention (10B) as seen in FIG. 9A, both the first cavity 71; and a second cavity 72, which is formed in the rear wall 65, causes the second cross-sectional dimension to be greater in the intermediate region 66 than the first cross-sectional dimension which is measured adjacent to the first and second ends 61 and 62, thereof. Still further, and referring to FIG. 10, another possible form of the invention 10 C includes a third cavity 73 which is formed in the top surface 63, and which forms a portion of the arch wire slot 14. Therefore, as discussed above, the second cross-sectional dimension which is measured at a location intermediate 66 the opposite first and second ends 61 and 62 is larger than the first cross-sectional dimension. As seen in FIGS. 11-13, the respective cavities 71, 72 and 73 cause a space 74 to be formed between the arch wire slot 14, and the adjacent arch wire 15. This space 74 minimizes any frictional contact between the bracket body 13, and the adjacent arch wire when the arch wire 15 is located in an orthodontically acceptable treatment position within the arch wire slot 14. In contrast, in the region of the first and second ends of the arch wire slot 61 and 62 (FIGS. 11 and 13) the top, bottom and rear wall surfaces 63, 64 and 65 which form the arch wire slot 14 are adjacent to, and substantially juxtaposed relative to the arch wire 15. These same surfaces closely hold the arch wire so as to allow an appropriate amount of torquing force and rotational control to be supplied by the arch wire 15 to the bracket body 13 so as to achieve the orthodontic objectives of the treatment regimen selected by the professional employing the various orthodontic bracket forms of the present invention. As will be understood, this enhanced rotational control extends across the entire width of the bracket body 13. Therefore, as seen in the drawings, the arch wire slot 14 which is formed in the bracket body 13 extends between the left and right sides 45 and 46 of the bracket body 13, and has a cross-sectional dimension which varies when measured along the arch wire slot 14 and between the left and right sides 45 and 46 of the bracket body. It has been discovered that this variable cross-sectional dimension of the arch wire slot 14 substantially reduces the amount of frictional force exerted by the bracket body 13 on the arch wire 15 while simultaneously retaining effective torquing force which is exerted across the whole width of the bracket body 13 so as to effectively accomplish the orthodontic treatment objectives. Still further, and as seen in FIGS. 11-13, the arch wire 15 is minimally frictionally engaged, at least in part, by the top, bottom and rearward surfaces 63, 64 and 65 of the arch wire slot 14 in the vicinity of the first and second ends 61 and 62 of the arch wire slot, and is further spaced from the bracket body 13 and the adjacent gate or slide as will be described below in the intermediate region 66 of the arch wire slot 14.

Referring still to FIG. 1, and following, it will be seen that in each of the respective forms of the orthodontic bracket as described herein 10A, 10B, 10C, etc., the respective orthodontic bracket forms each include a ligating slide or moveable gate which is generally indicated by the numeral 80. The moveable gate 80 has a main body 90, which is slideably borne by the base member 13, and which is further reciprocally moveable along a path of travel relative to the arch wire slot 14 in the fashion as will be described, hereinafter. The moveable gate 80 has a first superior end 91; a second inferior end 92; an anterior facing surface 93; and an opposite posterior facing surface 94. Still further, the main body 90 includes a first substantially vertically disposed peripheral edge 95, and a second, opposite, substantially vertically disposed peripheral edge 96 which is disposed in substantially parallel, spaced relation relative to the first peripheral edge. As seen in the drawings, the guide members 40 matingly receives and shields, at least in part, a portion of each of the opposite peripheral edges 95 and 96, respectively. As seen in FIG. 1 and following, the superior end 91 may be beveled or otherwise rounded or a combination of beveling or rounding so as to facilitate passive ligation of the arch wire 15, and more specifically to allow the moveable gate 80 to move substantially unimpeded past the arch wire 15 once it is placed in an orthodontically correct seated position within the arch wire slot 14 as seen in FIG. 7. As seen in FIGS. 3, 3A, 4, 4A, 5, 5A, 6, and 6A, the first superior end 91 may be beveled either uniformly 97; or non-uniformly as indicated by the numeral 98 depending upon the final form of the orthodontic bracket. Further, this first superior end may additionally be tapered from approximately the midpoint of the superior end outwardly towards the peripheral edges 95 and 96 in order to facilitate the closure of the gate 80. In all forms of the invention, however, this uniform or non-uniform beveling (97 or 98) facilitates the effective movement of the ligating slide or moveable gate 80 past the arch wire 15 and more specifically past the maximum arc magnitude 55 of the arch wire 15 and the first and second ends 61 and 62 of the arch wire slot 14. By the novel design as provided herein, the appropriate closure of the ligating slide or gate as seen in FIG. 8 is accomplished without substantial difficulty, and with greater comfort to the patient.

In one of its broadest aspects of the invention therefore, an orthodontic bracket 10A, 10B, 10C, etc. is disclosed and which includes a bracket body 13 defining an arch wire slot 14; an arch wire 15 received in the arch wire slot 14; and a moveable gate 80 cooperating with the bracket body 13, and which is moveable along a path of travel 100 (FIG. 7) between a first open position 101 which allows the arch wire 15 to be received in the arch wire slot 14, and a second closed position 102 (FIG. 8), and wherein the moveable gate 80 has a posterior facing surface 94 which does not substantially frictionally engage the moveable-gate 80 when the moveable gate moves between the first and second positions. This is seen most clearly by reference to FIG. 12.

Referring now to FIG. 1 and following, it will be seen that a first recessed region 111, and a second recessed region 112 are formed in the anterior facing surface 93 of the moveable gate 80 and adjacent to the first and second vertically disposed edges 95 and 96, respectively. These first and second recessed regions 111 and 112 each have a first end 113, which is positioned adjacent to the first superior end 91 of the main body 90; and a second end 114 which is spaced therefrom and oriented in spaced relation relative to the second inferior end 92. As seen in the drawings, the first and second recessed regions have a thickness dimension which facilitates the positioning of the respective recessed regions in the area therebetween the interior facing surface 42 of the respective guide members 40, and the base member 13 so as to permit the selective slideable movement of the ligating slide or gate 80 in the channel 43. As should be understood, this physical arrangement prohibits force which might be occasioned by a patient's chewing, for example, from adversely influencing the ligating slide or gate 80.

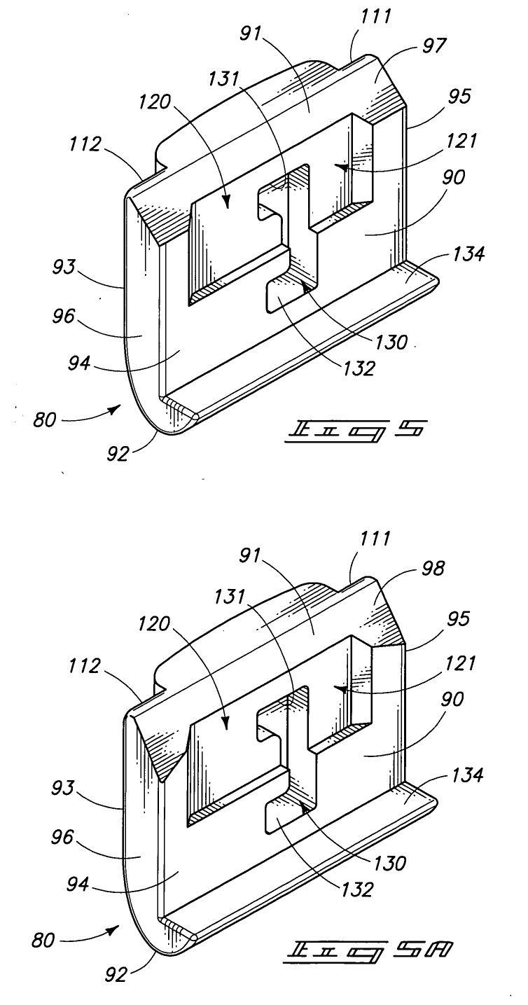

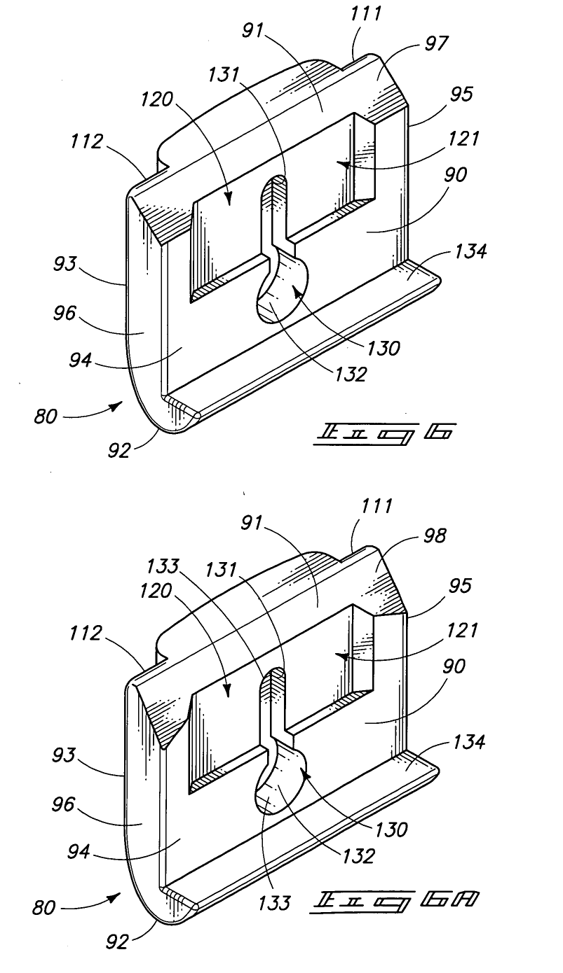

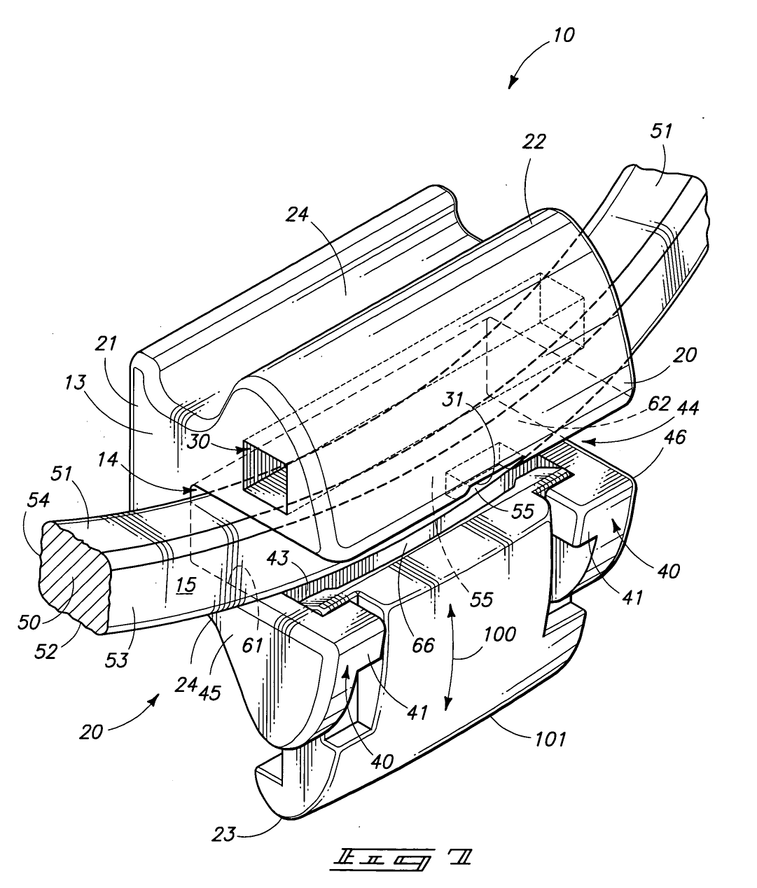

As will be appreciated from a study of FIG. 3 and following, a first cavity 120 of predetermined dimensions is formed in the posterior facing surface 94 of the main body 90 so as to minimize the frictional engagement of the arch wire 15, by the gate 80, as the gate is moved from the first open position 101, to the second closed position 102. This substantially eliminates sliding friction in the intermediate portion 66 and allows rotational control to be effective from either the first or second ends 61 and 62 of the arch wire slot 15 and across the entire width of the bracket body 13. This is in contrast to the prior art where the engagement of the arch wire by the intermediate region 66 or gate 80 prohibited the full rotational control of the bracket body 13. This of course limited, to some degree, the clinicians effective treatment of specific orthodontic anomalies. As earlier discussed, the superior end 91 of the gate 80 may beveled or tapered to also avoid any meaningful frictional engagement with the arch wire 15. As seen by references to FIGS. 5, 6, 5A and 6A, the first cavity 120 may comprise a cavity having a substantially uniform depth, length and width dimensions as indicated by the numeral 121. On the other hand, this same first cavity 120 may comprise a cavity having non-uniform dimensions 122 as seen most clearly by FIGS. 3, 4, 3A and 4A, respectively. Therefore, in one form of the invention, the cavity 120 formed in the posterior facing surface of the gate 80 has a substantially uniform length, width and/or depth dimension, and in another form of the invention, the cavity formed in the posterior facing surface of the gate 80 has a substantially non-uniform length, width and/or depth dimension. As seen in FIG. 3 and following, the first cavity 120 formed in the posterior facing surface of the gate is substantially concentrically oriented relative thereto. In the alternative, as will be recognized from the drawings, this same first cavity 120 could, in an alternative form of the invention (not shown) be excentrically oriented relative thereto. Therefore, in one form of the invention, the moveable gate 80 has a top or superior end 91, and a second or bottom or inferior end 92, and left and right lateral edges 95 and 96, respectively, and wherein the top or superior edge is beveled, rounded, and/or tapered, at least in part; and the left and right lateral edges, in the area of the posterior facing surface 94 of the moveable gate 80, does not substantially frictionally engage the arch wire 15 when the moveable gate is moved from the first open position 101 to the second closed position 102, so as to facilitate the closing of the gate 80 and thereby retaining the arch wire 15 in an orthodontically correct treatment position relative to the bracket body 13.

Referring to FIG. 3 and following, a second cavity 130 of predetermined dimensions, is formed in the posterior facing surface 94 of the ligating slide or gate 80 and is operable to cooperatingly mate with the post or resilient member 32: which extends normally outwardly relative to the anterior facing surface 20 of the bracket body 13 as earlier described. This second cavity 130 which is located within cavity 120 can be of various shapes as seen by references to FIGS. 3 and 4, for example. This second cavity 30 is disposed substantially centrally relative to the posterior facing surface 94, and has a first or superior end 131, and an opposite, second, or inferior end 132. Further, distally oriented abutting edges or ends 133 are formed at the first and second ends 131 and 132, and define the extreme ends of the course of travel 100 for the gate 80 between the first open position 101, and the second closed position 102 as seen in FIGS. 7 and 8. Because of the resiliency of the post or resilient member 32 as indicated, the gate 80 can be held in various locations along the path of travel 100 by frictional resistance exerted by the post, pin or resilient member 32 thereagainst the edge which defines the second cavity 130. It will be recognized, however, that with sufficient force applied by a clinician to the gate 80, the gate 80 may be readily moved from the first position 101 into a second cantilevered position 102 over the arch wire slot 14 thereby retaining or otherwise positioning the arch wire 15 in a clinically appropriate orthodontic treatment position relative to the orthodontic bracket body 13. As will be recognized, in the arrangement as seen in the drawings, the gate 80 is biasingly supported in at least one of the first or second positions 101 and 102, and this biasing force acts in a direction which is substantially parallel to the path of travel 100. This is contrary to prior art devices used heretofore, and wherein the prior art biasing assemblies typically provided a biasing force which was directed anteriorly outwardly, and in a direction which is generally normal to the path of movement 100 of the ligating slide or gate 80. As will be recognized from the drawings, the second cavity 130 has a depth dimension which is greater than or equal to the length dimension of the post resilient member 32 which extends anteriorly outwardly relative to the bracket body 13. Still further, the posterior facing surface 94 of the ligating slide gate 80 defines an abutting edge 134 which is operable to limit the movement of the ligating slide or gate 80 along a course of travel 100 when the abutting edge comes in contact with the bracket body 13. The present invention is not limited to the cantilevered gate 80 arrangement as seen in the drawings, but could be equally applied to bracket designs wherein the superior end of the gate matingly engages and is supported in part by the bracket body 13 when the gate is disposed in a closed position. Such a possible form of the invention is seen in my earlier patent application Ser. No. 12/147,872 and from which this application claims priority.

### Operation

The operation of the described embodiments of the present invention are believed to be readily apparent and are briefly summarized at this point.

In its broadest aspect, the present invention relates to an orthodontic bracket 10; 10A; 10B; and 10C, which includes a bracket body 13 having an arch wire slot 14 formed therein. Still further, the orthodontic bracket includes a movable gate 80 which slideably cooperates with the bracket body 13, and which further is moveable from a first, open position 101, to a second, closed position 102, and wherein the movable gate 80 has a posterior facing surface 94, and an anterior facing surface 93, and wherein, in the open position 101, an arch wire 15 is received in the arch wire slot 14. Further, a cavity 120 is formed in the posterior facing surface 94 of the gate 80 so as to minimize the frictional engagement of the arch wire 15 by the gate 80, as the gate 80 is moved from the first open position 101, to the second closed position 102. (See FIGS. 7 and 8). This allows for tighter arch wire slot 14 tolerances for more precise rotational control of the bracket body 13. Still further, these tighter tolerances permit the bracket body to be decreased in size, somewhat, so as to achieve a more aesthetically appealing appearance in the mouth of a patient.

Another aspect of the present invention relates to an orthodontic bracket 10; 10A; 10B; and 10C, etc. which includes a bracket body 13 having anterior and posterior facing surfaces 20 and 21, respectively, and left and right sides 45 and 46, and wherein an arch wire slot 14 is formed in the bracket body and extends between the left and right sides 45 and 46 of the bracket body 13. Still further, the arch wire slot 14 has a cross sectional dimension which varies when measured along the arch wire slot and between the left and right sides 45 and 46 of the bracket body. Still further, the orthodontic bracket 10 has a gate 80 which is slideably borne by the bracket body 13 and moveable between a first, open position 101, which permits an arch wire 15 to be received in the arch wire slot 14, and a second closed position 102, which captures the arch wire in the arch wire slot in an acceptable orthodontic treatment position, and wherein the arch wire slot 14 primarily frictionally engages the arch wire 15 in a region of the arch wire slot 14 which is adjacent to the left and right sidewalls 45 and 46 of the bracket body as seen in FIGS. 11-13, respectively. In the arrangement as seen in the drawings, the arch wire slot 14 is defined by a top and bottom surface 63 and 64, and a rearward or posterior oriented surface 65 which extends between the top and bottom surfaces. The arch wire slot has a first end 61 located adjacent to the left side of the bracket body 13, and a second end 62 located adjacent to the right side of the bracket body. Still further, the arch wire slot has an intermediate region 66 which is located between the first and second ends, and wherein the arch wire slot 14 has a non-uniform cross sectional dimension, and the intermediate region 66 which is located between the first and second ends thereof has a cross sectional dimension which is greater than the cross sectional dimension of the arch wire slot 14 when that is measured at the first and second ends 61 and 62 thereof. In one form of the invention, a cavity 71, 72 and/or 73 is formed in one of the top, bottom or rearward surfaces 63, 64 and 65 in the intermediate region 66 of the arch wire slot 14. In one form of the invention as seen in the drawings, the moveable gate 80 has a posterior facing surface 94, and a cavity or multiple cavities 120 is formed in the posterior facing surface so that the gate either does not, or only minimally frictionally engages the arch wire 15 as the gate 80 moves between the first, open position 101, and the second, closed position 102, and while the arch wire is located in an acceptable orthodontic treatment position (FIGS. 7 and 8). As seen in FIGS. 11 and 13, the arch wire 15 engages or rests in force transmitting contact thereagainst the bracket body 13 primarily in the vicinity of the first and second ends 61 and 62 of the arch wire slot 14; and is further spaced from the bracket body 13, and the gate 80, in the intermediate region 66 of the arch wire slot 14 (FIG. 12).

Another aspect of the present invention relates to an orthodontic bracket 10 which includes a bracket body 13 having an arch wire slot 14 formed therein, and which has a first, and a second end 61 and 62, respectively, and an intermediate region 66 therebetween, and wherein the arch wire slot 14 has a non-uniform cross sectional dimension when measured between the first and second ends 61 and 62 thereof. Further, the orthodontic bracket 10 includes a slideable gate 80 cooperating with the bracket body 13, and which is movable between a first, open position 101, and a second, closed position 102, and wherein an arch wire 15 is received in the arch wire slot 14 and is held in an acceptable orthodontic treatment position by the movable gate 80 when the gate is located in the second position 102. In this regard, the arch wire slot 14 frictionally and otherwise effectively engages the arch wire in the vicinity of the first and second ends 61 and 62 thereof, and has minimal frictional engagement or contact with the arch wire 15 in the intermediate region 66 thereof (FIG. 12). In the arrangement as seen in the drawings, the bracket body 13 has a width dimension, and wherein the arch wire slot has a length dimension which extends across the width dimension of the bracket body 13. In the several forms of the invention as shown, the arch wire 15 applies a torquing force to the bracket body 13 when located in the orthodontic treatment position as seen in FIG. 8 and which extends substantially across the entire width dimension of the bracket body 13. In the arrangement as seen in the drawings, the arch wire 15, when placed in the orthodontic treatment position as seen in FIG. 8 and in the arch wire slot 14 lies along an arc having a given maximum arc magnitude 55 relative to the arch wire slot 14. This is seen in FIG. 8A, and wherein the moveable gate 80 does not substantially frictionally engage the arch wire 15 at the maximum arc magnitude of the arch wire 15 (FIG. 12). Again as discussed earlier in this application, the arch wire slot 14 has a cross sectional dimension which is greatest in the intermediate region 66 thereof and has a cross-sectional dimension which is the least at a location adjacent the first and second ends 61 and 62 thereof. In order to achieve the benefits of the present invention, a cavity 71, 72 and/or 73 is formed in the arch wire slot 14 in the intermediate region 66 thereof. As earlier discussed, these cavities 71, 72 and 73 may be formed individually, or in each of the top, bottom and rearward surfaces 63, 64 and 65 of the bracket body defining the arch wire slot 14. Further, a cavity 120 may be formed in the posterior surface 94 of the gate 90. Moreover, the superior end 91 of the gate 80 is beveled, rounded and/or tapered so as to effectively move past the arch wire 15 without substantially frictionally engaging the arch wire in the vicinity of the maximum arc magnitude 55, and elsewhere, as the gate moves to the closed position. All of these cavities, as earlier discussed, are located at or near the intermediate region 66 of the arch wire slot 14. In combination, these features permit the easy closure of the gate 80 in a manner not possible heretofore.

Another aspect of the present invention relates to an orthodontic bracket which includes a bracket body 13 having anterior and posterior facing surfaces 20 and 21; and a substantially transversely disposed arch wire slot 14 is formed in the bracket body 13, and which is configured to receive an arch wire 15 therein. In the arrangements as seen in the drawings, a movable gate 80 is provided and which is borne by the bracket body, and which is operable when placed in a first, open position 101, allows the arch wire to be received in the arch wire slot 14, and wherein the moveable gate 80 has an anterior facing surface 93, and an opposite posterior facing surface 94. The gate 80 slideably cooperates with the bracket body 13 so as to releasably secure the moveable gate 80 in a second, closed position 102, and further retains the arch wire 15 in the arch wire slot 14 in an orthodontic treatment position, as seen in FIG. 8, relative to the bracket body 13. A portion of the posterior facing surface 94 of the gate 80 forms a cavity 120 and the top, superior end 91 of the gate 80 is beveled, rounded and/or tapered such that the arch wire 15 is not substantially frictionally engaged by the moveable gate 80 at it moves between the first, open position 101 to the second closed position 102. In addition to the foregoing, and as earlier discussed, a cavity 71, 72 and/or 73 is formed in one of the top 63, bottom 64, and/or rearward surfaces 65 which define the arch wire slot 14, or a cavity 120 is formed in the posterior surface 94 of the slideable gate 80 all of which, in combination, reduces the amount of friction experienced by the arch wire 15 when the arch wire 15 is located in the orthodontic treatment position as seen in FIG. 8 and within the bracket body 13. In the arrangement as seen in the drawings, and with the provision of the first, second and/or third cavities 71, 72 and 73, and the cavity 120 formed in the posterior surface 94 of the gate 80, the arch wire 15 is effectively spaced from one of the arch wire slot 14, or the slideable gate 80 in the vicinity of the intermediate portion 66 of the arch wire slot 14. As earlier discussed therefore, the bracket body 13 remains in force receiving relation relative to the arch wire 15 in the vicinity of the first and second ends 61 and 62 of the arch wire slot. In this arrangement therefore, the torque exerted by the arch wire 15 on the bracket body 13 can be exerted across the entire width of the bracket body to achieve orthodontic treatment benefits not possible heretofore, but further reduces the amount of friction exerted by the bracket body on the arch wire, and additionally, facilitates the easy closure of the gate 80 when it is being moved from the first open position 101 to the second closed position 102. Still further, as a patient's tooth moves to an orthodontically acceptable position within the patient's mouth, the bracket body 13 easily moves along the arch wire 15 with minimal frictional resistance. Additionally, the arrangement of the gate 80 thereby prevents the gate from hanging up on, or otherwise adversely frictionally engaging the arch wire 15 when it is placed in the arch wire slot 14 so as to substantially assist the clinician in closing the gate 80 and thereby enclose the arch wire 15 in the acceptable orthodontic treatment position as seen in FIG. 8. Therefore, in the arrangement as seen in the drawings, the bracket body 13 minimally engages the arch wire 15 in the vicinity of the first and second ends 61 and 62 of the arch wire slot 15, and has minimal or no contact with the arch wire in the vicinity of the intermediate region 66 of the arch wire slot 14 as seen in FIG. 12 of the drawings.

Therefore, it will be seen that the present invention relates to an orthodontic bracket which provides many benefits not possible in the prior art devices which have been disclosed heretofore, and further provides many benefits to a clinician when utilizing such orthodontic bracket in the treatment of a patient.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. An orthodontic bracket, comprising:
a ligating slide coupled to a base member, and moveable along a path of travel relative thereto, and wherein a biasing member is borne by the ligating slide and cooperates with a portion of the base member to releasably position the ligating slide relative to the base member, and wherein the biasing member exerts a biasing force which acts in a direction which is substantially parallel to the path of travel.

2. An orthodontic bracket as claimed in claim 1, and wherein the base member has an anterior and posterior surface, and wherein an archwire slot having an opening is formed in the anterior surface.

3. An orthodontic bracket as claimed in claim 2, and wherein the portion of the base member comprises a fixed projection which extends anteriorly outwardly relative to the base member, and wherein the base member defines a bore which extends between the anterior and a posterior facing surfaces of the base member, and wherein the fixed projection is inserted into the bore from the posterior facing surface of the base member.

4. An orthodontic bracket as claimed in claim 2, and wherein the portion of the base member comprises a fixed projection which extends posteriorly outwardly relative to the base member.

5. An orthodontic bracket as claimed in claim 2, and wherein the base member has a lowermost portion, and wherein a channel is formed in the anterior surface of the base member and which extends from the archwire slot to the lowermost portion, and wherein the portion of the base member which cooperates with the biasing member comprises a projection which extends anteriorly outwardly and into the channel.

6. An orthodontic bracket as claimed in claim 5, and wherein the ligating slide slideably cooperates with the lowermost portion of the base member, and is further moveable between a first position which is clear of the archwire slot, and a second position where the ligating slide projects, at least in part, over the opening of the archwire slot.

7. An orthodontic bracket as claimed in claim 6, and wherein the ligating slide has opposite peripheral edges, and wherein the lowermost portion of the base member shields, at least in part, a portion of each of the opposite peripheral edges.

8. An orthodontic bracket as claimed in claim 1, and wherein the ligating slide is resiliently deformable, and has a beveled superior end which faces in the direction of the archwire slot.

9. An orthodontic bracket as claimed in claim 4, and wherein the base member has a lowermost portion, and wherein a channel is formed in the anterior surface of the base member, and wherein the ligating slide is slideably received, at least in part, in the channel, and slideably cooperates with the lowermost portion of the base member, and is further moveable between a first position which is clear of the archwire slot, and a second position where the ligating slide projects over the opening of the archwire slot.

10. An orthodontic bracket as claimed in claim 9, and wherein the posterior surface of the base member defines a passageway which receives a portion of the ligating slide, and wherein the fixed projection extends posteriorly outwardly and partially occludes the passageway.

11. An orthodontic bracket as claimed in claim 10, and wherein the ligating slide has a first portion, which is slideably received in the channel which is defined by the lowermost portion of the base member, and a second portion which is disposed in predetermined spaced relation relative to the first portion, and wherein the biasing member is made integral with the second portion, and wherein the second portion of the ligating slide is sized so as to be slideably received within the passageway which is defined by the posterior surface of the base member.

12. An orthodontic bracket as claimed in claim 11, and wherein the first portion of the ligating slide is resiliently deformable so as to facilitate passive self-ligation.

13. An orthodontic bracket as claimed in claim 12, and wherein the first portion of the ligating slide has opposite peripheral edges, and wherein the lowermost portion of the base member shields, at least in part, a portion of each of the opposite peripheral edges.

14. An orthodontic bracket as claimed in claim 2, and wherein the base member, and ligating slide define substantially continuous upper and lower tie wing projections.

15. An orthodontic bracket as claimed in claim 2, and wherein the ligating slide is moveable relative to the base member between a first portion which is substantially clear of the archwire slot, and a second position where the ligating slide projects, at least in part, over the archwire slot.

16. An orthodontic bracket as claimed in claim 15, and wherein the ligating slide has a superior peripheral edge which abuts, at least in part, the base member when the ligating slide is in the second position.

17. An orthodontic bracket as claimed in claim 15, and wherein the ligating slide has a superior peripheral edge which partially overlaps the base member when the ligating slide is in the second position.

18. An orthodontic bracket as claimed in claim 2, and wherein the base member defines a bore, and wherein the portion of the base member which cooperates with the biasing member comprises a projection which is received, at least in part, within the bore and which further extends outwardly relative thereto.

19. An orthodontic bracket as claimed in claim 2, and wherein the base member further defines a transverse passageway which extends through the base member and which is disposed in spaced relation relative to the archwire slot, and wherein the transverse passageway receives an orthodontic appliance which facilitates passive self-ligation.

20. An orthodontic bracket as claimed in claim 19, and wherein the transverse passageway is operable to receive and cooperate with a torquing spring; secondary archwire; post; removable, horizontally disposed hook, and/or other orthodontic appliances.

21. An orthodontic bracket as claimed in claim 2, and wherein the ligating slide is moveable relative to the base member between a first position where the ligating slide is clear of the archwire slot, and a second position where the ligating slide projects, at least in part, over the archwire slot, and abuts the base member, and wherein a recessed region is defined therebetween the ligating slide and the base member when the ligating slide is located in the second position and which permits an instrument to be inserted therein, and which can exert force on the ligating slide to move the ligating slide from the second position to the first position.

22. An orthodontic appliance as claimed in claim 2, and wherein the ligating slide is moveable relative to the base member between a first position which is clear of the archwire slot, to a second position where the ligating slide projects over the opening of the archwire slot, and wherein the biasing member has a first and a second portion, and wherein the portion of the base member which cooperates with the biasing member comprises a projection which extends outwardly relative to the base member, and wherein the first portion of the biasing member receives the projection when the ligating slide is in the first position, and the second portion of the biasing member receives the projection when the ligating slide is in the second position relative to the base member.

23. An orthodontic bracket as claimed in claim 22, and wherein the biasing member is substantially planar.

24. An orthodontic bracket as claimed in claim 22, and wherein the biasing member is defined, at least in part, by a pair of members having opposing peripheral edges, and wherein a channel is defined between the opposing peripheral edges, and wherein the pair of members cooperate with the projection to position the ligating slide in the second position.

25. An orthodontic bracket comprising:
a base member defining an archwire slot having an opening and at least one projection extending outwardly relative to the base member;
a ligating slide moveably borne by the base member between a first position where the ligating slide is clear of the archwire slot, and a second position where the ligating slide projects over the opening of the archwire slot; and
a biasing member borne by the ligating slide and slideably cooperating with the projection, and wherein the biasing member has a first portion which receives the projection when the ligating slide is in the first position, and a second portion which receives the projection when the ligating slide is in the second position.

26. An orthodontic bracket as claimed in claim 25, and wherein the projection extends anteriorly outwardly relative to the base member.

27. An orthodontic bracket as claimed in claim 25, and wherein the projection extends posteriorly outwardly relative to the base member.

28. An orthodontic bracket as claimed in claim 25, and wherein the ligating slide moves along a path of travel between the first and second position, and wherein the biasing member is substantially planar, and exerts a biasing force which acts in a direction which is perpendicular relative to the projection, and in substantially parallel spaced relation relative to the path of travel of the ligating slide.

29. An orthodontic bracket as claimed in claim 25, and wherein the biasing member is defined, at least in part, by a pair of spaced, resilient members which define a channel therebetween, and wherein the projection is received in, and moves along the channel when the ligating slide moves between the first and second positions, and wherein the resilient members resiliently engage the projection as the ligating slide moves between the first and second positions.

30. An orthodontic bracket as claimed in claim 25, and wherein the base member further defines a transverse passageway which extends through the base member, and which is disposed in substantially parallel, spaced relation relative to the archwire slot.

31. An orthodontic bracket as claimed in claim 30, and further comprising a torquing spring having a first portion which is received in the transverse passageway, and a second portion which extends outwardly relative to the base member and which exerts a torquing force on the base member.

32. An orthodontic bracket as claimed in claim 25, and wherein the ligating slide is resiliently deformable so as to facilitate passive ligation.

33. An orthodontic bracket as claimed in claim 25, and wherein the base member has an anterior and a posterior side, and further defines a bore which is dimensioned to receive, at least in part, a portion of the projection, and wherein the projection is inserted into the bore from the posterior side of the base member.

34. An orthodontic bracket as claimed in claim 33, and wherein the bore extends through the base member.

35. An orthodontic bracket as claimed in claim 33, and wherein the bore does not extend through the base member.

36. An orthodontic bracket as claimed in claim 25, and wherein the base member has an anterior and a posterior side, and further defines a substantially vertically oriented passageway which is disposed in spaced relation relative to the posterior side of the base member, and wherein the projection extends posteriorly outwardly relative to the base member and into the vertically oriented passageway.

37. An orthodontic bracket as claimed in claim 36, and wherein the ligating slide has a first portion which projects over the opening of the archwire slot when the ligating slide is in the second position, and a second portion which is located in spaced relation relative to the first portion, and which is telescopingly received in the vertically oriented passageway, and wherein the biasing member is made integral with the second portion.

38. An orthodontic bracket, comprising:
a base member defining a transverse archwire slot having an opening;
a ligating slide borne by the base member and moveable along a path of travel relative to the archwire slot, and wherein the ligating slide is moveable between a first position where the ligating slide allows access to the archwire slot, and a second position, where the ligating slide projects over the opening and restricts access to the archwire slot, and wherein a biasing member is mounted on the ligating slide and biasingly supports the ligating slide in at least one of the first or second positions, and wherein the biasing member exerts a biasing force in a direction relative to the base member which is substantially parallel and in non-coaxial alignment relative to the path of travel of the ligating slide.

39. An orthodontic bracket, comprising:
a base member having a transverse archwire slot defining an opening, and at least one projection extending outwardly from the base member;
a ligating slide moveable between a first position which is clear of the archwire slot, and a second position where the ligating slide projects over the opening of the archwire slot; and
a substantially planar biasing member borne by the ligating slide and matingly cooperating with the projection, and wherein a first portion of the biasing member receives the projection when the ligating slide is in the first position, and a second portion of the biasing member receives the projection when the ligating slide is in the second position.

40. An orthodontic bracket, comprising:
a base member defining an archwire slot having an opening, and a transverse passageway substantially parallel to the archwire slot; and
a ligating slide borne by the base member and moveable relative to the archwire slot, and wherein the ligating slide is moveable between a first position where the ligating slide is clear of, and allows access to, the archwire slot, and a second position where the ligating slide projects over, and restricts access to the archwire slot.

41. An orthodontic bracket, comprising:
a base member having a posterior facing surface, an anterior facing surface, and a projection extending anteriorly or posteriorly outwardly from one of the anterior and/or posterior facing surfaces, and wherein, the projection has an outwardly facing surface; and
a ligating slide moveably borne by the base member along a path of travel, and further having a pair of members having opposing surfaces, and a channel defined therebetween the opposing surfaces, and wherein the pair of members resiliently cooperate with the outwardly facing surface of the projection to exert a biasing force on the ligating slide which is in substantially parallel, spaced non-coaxial relation relative to the path of travel.

42. An orthodontic bracket comprising:
a base member having a posterior facing surface, and an anterior facing surface, and wherein a projection extends outwardly from the posterior facing surface, and wherein the anterior facing surface of the base member defines an archwire slot having an opening; and
a ligating slide borne by the base member and moveable between a first position which allows access to the archwire slot through the opening, and a second position which restricts access to the archwire slot through the opening, and wherein the ligating slide comprises a first portion extending to a second portion, and wherein the first portion forms, at least in part, a portion of the anterior facing surface of the base member, and the second portion is positioned in adjacent spaced relation relative to the posterior facing surface of the base member; and
a resilient-biasing member made integral with the second portion of the ligating slide and which resiliently cooperates with the projection.

43. An orthodontic bracket, comprising:
a base member;
an archwire slot traversing the base member, and wherein the archwire slot defines an opening within an anterior surface of the base member;
a channel extending along the anterior surface of the base member from the archwire slot to a lowermost surface of the base member;
a fixed projection extending laterally outwardly from the base member and into a portion of the channel;
a ligating slide which is slideably received in the channel; and
a biasing member borne by the ligating slide and which resiliently cooperates with the fixed projection.

44. An orthodontic bracket, comprising:
a ligating slide having a biasing member which is defined, at least in part by a pair of members with opposing surfaces, and wherein the opposing surfaces define a channel therebetween, and wherein the members are spaced, and resiliently moveable one relative to the other and are operable to exert a biasing force on the ligating slide, and wherein the ligating slide is moveable along a path of travel and the biasing force is substantially parallel and in spaced relation relative to the path of travel; and
a biasing abutment is defined by one of the surfaces of one of the members, and wherein the biasing abutment at least partially occludes the channel.

45. An orthodontic bracket, comprising:
a base member having anterior and posterior facing surfaces, and further defining an archwire slot having an opening in the anterior facing surface;
a ligating slide moveably borne by the base member and which is moveable between a first position which is clear of the archwire slot, and a second position where the ligating slide projects over the archwire slot; and
a biasing member borne by the base member and resiliently cooperating with the ligating slide, and wherein the biasing member exerts a biasing force which is directed outwardly relative to the base member so as to position the ligating slide in the first and second positions.

46. An orthodontic bracket as claimed in claim 45, and wherein a cavity is formed in the base member and is operable to receive, at least in part, the biasing member.

47. An orthodontic bracket as claimed in claim 45, and wherein a cavity is formed in the base member and which receives, at least in part, the biasing member, and wherein the biasing member is inserted within the cavity from the posterior facing surface.

48. An orthodontic bracket as claimed in claim 45, and wherein the ligating slide has a first portion which projects over the archwire slot when oriented in the second position, and a second portion which is resiliently engaged by the biasing member.

49. An orthodontic bracket as claimed in claim 48, and wherein the base member defines a substantially vertically oriented passageway which is positioned in spaced relation relative to the posterior facing surface, and wherein the second portion of the ligating gate is slideably received in the passageway, and wherein a detent is formed in the second portion of the ligating slide and which cooperates with the biasing member so as to position the ligating slide in the first and second positions.

50. An orthodontic bracket as claimed in claim 48, and wherein the first portion of the ligating slide is resiliently deformable so as to facilitate passive ligation.

51. An orthodontic bracket as claimed in claim 45, and wherein the base member further defines a transverse passageway which extends through the base member and which is substantially parallel to the archwire slot.

52. An orthodontic bracket as claimed in claim 45, and wherein the base member and the ligating slide define, at least in part, substantially continuous tie wings.

53. An orthodontic bracket as claimed in claim 45, and wherein the biasing member comprises a resiliently deformable o-ring.

54. An orthodontic bracket as claimed in claim 45, and wherein the base member further defines a transverse passageway which is disposed in substantially parallel spaced relation relative to the archwire slot and which cooperates with another orthodontic appliance.

55. An orthodontic bracket as claimed in claim 54, and wherein the other orthodontic appliance comprises a removable horizontally disposed hook having a main body which matingly cooperates with a transverse passageway, and wherein the main body has a distal end which can be readily deformed so as to releasably secure the horizontally disposed hook within the transverse passageway.

56. An orthodontic bracket, comprising:
a base member defining an archwire slot having an opening, and a transverse passageway which is substantially parallel to the archwire slot; and
a ligating slide which movably cooperates with the base member and which operates, when located in a first position, to allow access to the archwire slot, and further when moved along a path of travel to a second position restricts access to the archwire slot by covering the opening, and wherein the ligating slide has a posterior facing surface which has a cavity formed therein, and which is dimensioned to receive a biasing member which biasingly cooperates with the base member so as to produce a biasing force which releasably secures the ligating slide in one of the first or second positions, and wherein the biasing force acts in a direction which is substantially parallel to the path of travel of the ligating slide.

57. An orthodontic bracket as claimed in claim 56, and wherein the cavity formed in the posterior facing surface of the ligating slide has an open, first, superior end, and a closed, second, inferior end, and further has a depth dimension which is greater than or equal to a thickness dimension of the biasing member.

58. An orthodontic bracket as claimed in claim 56, and wherein the ligating slide has a superior end which abuts the base member when the ligating slide is in the second position which restricts access to the archwire slot.

59. An orthodontic bracket as claimed in claim 57, and wherein the superior end of the ligating slide is rounded or beveled.

60. An orthodontic bracket as claimed in claim 56, and wherein the ligating slide has a superior end which at least partially overlaps the base member when the ligating slide is in the second position which restricts access to the archwire slot.

61. An orthodontic bracket as claimed in claim 60, and wherein the superior end of the ligating slide releasably cooperates with the base member when the ligating slide is in the second position which restricts access to the archwire slot.

62. An orthodontic bracket comprising:
a base member defining an archwire slot;
a ligating slide borne by the base member and moveable between a first, open position which allows access to the archwire slot, and a second, closed position which restricts access to the archwire slot, and wherein the ligating slide has an anterior and a posterior facing surface, and wherein a channel is formed in the posterior facing surface of the ligating slide; and
an elongated flexible member borne by the base member and which has a distal end which is received in the channel, and wherein the distal end is resiliently deformable along a substantially arcuately shaped path of travel, and wherein the flexible member cooperates with the channel to releasably secure the ligating slide in the first and second positions.

63. An orthodontic bracket as claimed in claim 62, and wherein the base member has an anterior and a posterior facing surface, and a bore is formed in the base member and extends between the anterior and a posterior facing surfaces, and wherein the flexible member has a proximal and a distal end, and is further inserted in the base member from the posterior surface of the base member, and the distal end thereof extends anteriorly outwardly relative to the anterior facing surface of the base member, and the proximal end is affixed to the posterior facing surface of the base member.

64. An orthodontic bracket as claimed in claim 63, and wherein the bore formed in the base member has a first end which is adjacent to the posterior facing surface of the base member, and a second end which is adjacent to the anterior facing surface of the base member, and wherein the diametral dimension of the second end of the bore is greater than the first end of the bore.

65. An orthodontic bracket as claimed in claim 63, and wherein the arcuately shaped path of travel is generally parallel to the anterior facing surface of the base member.

66. An orthodontic bracket as claimed in claim 63, and wherein the flexible member is not longitudinally deformable.

67. An orthodontic bracket as claimed in claim 63, and wherein the channel has a first and a second end, and wherein a seat is defined at the first and second ends and which are each dimensioned to matingly receive the flexible member, and wherein the flexible member is not substantially deformed when received in the respective seats, and wherein the movement of the ligating slide between the first and second positions causes the flexible member to resiliently deform and move out of the respective seats and along the channel defined in the posterior facing surface of the ligating slide.

68. An orthodontic bracket as claimed in claim 62, and wherein the base member has a lowermost portion which defines a channel that extends from the archwire slot to the lowermost portion, and wherein the ligating slide is slideably received in the channel defined by the lowermost portion of the base member.

69. An orthodontic bracket as claimed in claim 62, and wherein the ligating slide is resiliently deformable and has a superior end which is rounded or beveled, at least in part.

70. An orthodontic bracket as claimed in claim 62, and wherein the ligating slide has opposite peripheral edges, and wherein the base member shields, at least in part, the opposite peripheral edges.

71. An orthodontic bracket as claimed in claim 62, and wherein the base member further defines a transverse passageway which extends through the base member, and which is disposed in spaced relation relative to the archwire slot.

72. An orthodontic bracket comprising:
a base member defining an archwire slot;
an elongated flexible member borne by the base member, and which has a distal end which is moveable along a path of travel, and which flexes relative to a central axis thereof; and
a ligating slide moveably borne by the base member between a first position where the ligating slide is clear of the archwire slot, and a second position where the ligating slide restricts access to the archwire slot, and wherein the distal end of the elongated flexible member cooperates with the ligating slide and moves along the arcuately shaped path of travel as the ligating slide moves between the first and second positions.

73. An orthodontic bracket as claimed in claim 72, and wherein the base member has an anterior and a posterior facing surface, and wherein the base member further defines a transverse passageway which is disposed in spaced relation relative to the archwire slot.

74. An orthodontic bracket as claimed in claim 73, and wherein the flexible member extends anteriorly outwardly relative to the base member, and further flexes in a generally radial direction.

75. An orthodontic bracket as claimed in claim 74, and wherein the flexible member has an opposite proximal end, and wherein the base member defines a bore which extends between the anterior and posterior facing surfaces thereof, and wherein the flexible member is received in the bore, and the proximal end of the flexible member is located adjacent to the posterior facing surface of the base member.

76. An orthodontic bracket as claimed in claim 75, and wherein the bore which receives the flexible member has an increasing diametral dimension when measured in a direction which extends from the posterior facing surface of the base member, to the anterior facing surface thereof.

77. An orthodontic bracket as claimed in claim 76, and wherein the ligating slide has an anterior and a posterior facing surface, and wherein a channel is formed in the posterior facing surface and which receives the distal end of the flexible member, and wherein the channel has a first and second end, and wherein first and second seats are individually formed on the respective first and second ends, and wherein an intermediate portion extends therebetween the first and second seats, and wherein the distal end of the flexible member is located in the first seat when the ligating slide is located in the first position where the ligating slide is clear of the archwire slot, and is further located in the second seat when the ligating slide is located it the second position which restricts access to the archwire slot, and wherein the flexible member travels along the intermediate portion of the channel, and simultaneously moves along the path of travel when the ligating slide moves from the first position to the second position.

78. An orthodontic bracket as claimed in claim 77, and wherein the flexible member when located in the first or second seat releasably secures the ligating slide in the first or second positions.

79. An orthodontic bracket as claimed in claim 78, and wherein the first and second seats are located in substantially perpendicular relation relative to the intermediate portion of the channel.

80. An orthodontic bracket as claimed in claim 72, and wherein the ligating slide is resiliently deformable when located in the second position so as to facilitate passive self-ligation.

81. An orthodontic bracket as claimed in claim 72, and wherein the distal end of the flexible member remains undeformed when the ligating slide is located in the first or second position.

82. An orthodontic bracket comprising:
a base member having an anterior and posterior facing surfaces, and which further defines a transverse archwire slot having an opening;
a ligating slide which is moveably borne by the base member between a first position, where the ligating slide is clear of the archwire slot, and a second position, where the ligating slide projects over the opening of the archwire slot, and wherein the ligating slide moves along a path of travel between the first and second positions;
a resilient member borne by the base member and cooperating with the ligating slide to releasably restrain the ligating slide in the first and second positions, and wherein the resilient member is resiliently deformed, when the ligating slide moves between the first and second positions;
a transverse passageway formed in the base member and disposed in spaced relation relative to the archwire slot; and
an orthodontic appliance received, at least in part, in the transverse passageway and which facilitates passive self-ligation.

83. An orthodontic bracket as claimed in claim 82, and wherein the transverse passageway has a square or rectangular shape and wherein the orthodontic appliance comprises a torquing assembly which has a first portion which is matingly received in the transverse passageway, a resiliently deformable intermediate portion which is affixed to the first portion, and a second portion which is affixed to the intermediate portion and which is located outside of the transverse passageway.

84. An orthodontic bracket as claimed in claim 83, and wherein the second portion of the torquing assembly may be rotated so as to resiliently deform the intermediate portion of the torquing assembly.

85. An orthodontic bracket as claimed in claim 82, and wherein the transverse passageway has a square or rectangular shape, and wherein the orthodontic appliance comprises a hook which has a rectangular shaped main body which is matingly received, at least in part, in the transverse passageway, and further has a distal end which may be permanently deformed so as to prevent removal of the hook from the transverse passageway.

86. An orthodontic bracket as claimed in claim 82, and wherein the ligating slide is resiliently deformable when located in the second position so as to facilitate passive self-ligation.

87. An orthodontic bracket as claimed in claim 82, and wherein the ligating slide has a posterior facing surface, and a channel is formed in the posterior facing surface, and wherein the resilient member has a distal end which is receive in and moves along the channel when the ligating slide moves between the first and second positions.

88. An orthodontic bracket, comprising:
a base member defining an archwire slot, and which has anterior, posterior, superior and inferior facing surfaces, and wherein the base member defines a passageway which is located adjacent to the posterior facing surface and which extends therebetween the superior and inferior facing surface;
an elongated flexible member borne by the base member and extending posteriorly outwardly relative to the base member and into the passageway, and wherein the elongated flexible member has a distal end which is moveable along an arcuately shaped path of travel; and
a ligating slide which is received, at least in part, in the passageway, and which cooperates with the elongated flexible member, and wherein the ligating slide is moveable from a first position where the ligating slide is clear of the archwire slot, to a second position where the ligating slide restricts access to the archwire slot.

89. An orthodontic bracket as claimed in claim 88, and wherein the ligating slide is resiliently deformable so as to facilitate passive self-ligation.

90. An orthodontic bracket as claimed in claim 88, and wherein the ligating slide has a first portion, and a second portion which is located in spaced relation relative to the first portion, and wherein the second portion is sized so as to be slideably received within the passageway as defined by the base ember, and wherein the flexible member cooperates with the second portion of the ligating slide.

91. An orthodontic bracket as claimed in claim 90, and wherein the second portion of the ligating slide defines a channel which receives the distal end of the elongated flexible member, and wherein the movement of the ligating slide from the first position to the second position causes the distal end of the elongated flexible member to travel along the channel and simultaneously move along the arcuately shaped path of travel.

92. An orthodontic bracket as claimed in claim 88, and wherein the base member defines a bore which receives, at least in part, the elongated flexible member, and wherein the bore is sized so as to facilitate the movement of the distal end of the elongated flexible member along the arcuately shaped path of travel.

93. An orthodontic bracket as claimed in claim 88, and wherein the base member defines a transverse passageway which extends through the base member, and which is disposed in spaced relation relative to the archwire slot.

94. An orthodontic bracket as claimed in claim 88, and wherein the elongated flexible member is not longitudinally deformable.

95. An orthodontic bracket as claimed in claim 93, and further comprising an orthodontic appliance received, at least in part, in the transverse passageway and which facilitates passive self-ligation.

96. An orthodontic bracket as claimed in claim 95, and wherein the orthodontic appliance comprises a hook or a torquing assembly.
